(19) United States
(12) Patent Application Publication
(10) Pub. No.: US 2024/0061995 A1
(43) Pub. Date: Feb. 22, 2024

(54) INTELLIGENT DETECTION OF DOCUMENT READINESS

(71) Applicant: Microsoft Technology Licensing, LLC, Redmond, WA (US)

(72) Inventors: Amund TVEIT, Trondheim (NO); Mustafe Ahmed FARAH, Oslo (NO); Srdan PRODANOVIC, Trondheim (NO); Torbjørn HELVIK, Oslo (NO); Jeanine LILLENG, Trondheim (NO); Jørgen Vinne IVERSEN, Trondheim (NO); Øystein FLEDSBERG, Trondheim (NO); Aleksander ØHRN, Trondheim (NO); Andrew Parker LEACH, Seattle, WA (US); Thomas FAGERLIE GUNDERSEN, Trondheim (NO); Øystein TORBJØRNSEN, Trondheim (NO)

(21) Appl. No.: 17/891,595

(22) Filed: Aug. 19, 2022

(51) Int. Cl. G06F 40/194

(52) U.S. Cl. CPC G06F 40/194

(57) ABSTRACT

A method for intelligently evaluating sharing readiness of a document stored on a sharing platform includes determining, for each of multiple versions of the document, a deviation metric quantifying similarity of the version with another consecutively-saved version of the document; evaluating the deviation metrics for the document in view of predefined readiness criteria indicative of sharing readiness; and presenting a sharing recommendation on a user interface of the sharing platform responsive to determining that a subset of the deviation metrics for the document satisfy the predefined readiness criteria.

### BACKGROUND

Users often create and store documents within web-based sharing platforms designed to support multi-user collaboration. However, many documents created on these platforms are never shared. Some collected statistics indicate that as many as 90% of created documents are never read by anyone other than the author. The storage of millions of unshared documents by sharing platforms amounts to significant waste, both in terms of cloud-based resources and also in terms of missed peer-to-peer educational opportunities.

### SUMMARY

According to one implementation, a method for intelligently detecting document readiness includes determining, for each of multiple saved versions of a document, a deviation metric quantifying similarity of the version with a consecutively-saved version. The determined deviation metrics are evaluated in view of predefined readiness criteria indicative of sharing readiness. Responsive to determining that a subset of the determined deviation metrics satisfy the predefined readiness criteria, a sharing recommendation is presented on a user interface of the sharing platform.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Other implementations are also described and recited herein.

### BRIEF DESCRIPTION OF THE DRAWINGS

FIG. 1 illustrates features of an example web-based document creation and sharing platform that automatically assesses documents for sharing readiness and that automatically generates intelligent sharing recommendations.

FIG. 2 illustrates example deviation metrics computed for different versions of an in-progress document that are usable to evaluate document sharing readiness.

FIG. 3 illustrates a sharing platform with a sharing readiness predictor that predicts document sharing readiness.

FIG. 4 illustrates an example intelligent sharing recommendation system that uses sharing history data of documents previously shared on a sharing platform to train AI to predict criteria usable to evaluate whether a particular document is ready for sharing.

FIG. 5 illustrates another example intelligent sharing recommendation system that uses sharing history data of documents previously shared on a sharing platform to train an AI to make intelligent sharing recommendation.

FIG. 6 illustrates example operations for intelligently generating sharing recommendations

FIG. 7 illustrates an example schematic of a processing device suitable for implementing aspects of the disclosed technology.

### DETAILED DESCRIPTION

Research indicates that perceived psychological safety is a key factor that drives an individual's willingness and desire to collaborate with others on a team. Likewise, research has also shown that greater workplace collaboration correlates with higher productivity and higher productivity, in turn, translates to a cost savings for employers. Effective incentives to increase workplace collaboration can therefore lead to yields in both productivity and monetary gain.

A web-based document creation and sharing platform may include certain user interface (UI) features that permit a user to selectively “share” a document with other users and thereby grant those other users read and/or write access. For example, available in-platform tools may provide the user with options to share the document with a limited group of users (e.g., the user's workplace team, such as to solicit feedback on the draft) and/or to publish the document to a wider audience, such as to the user's entire organization. To encourage users to make use of these sharing features (and benefits from gains to their own productivity), the herein disclosed sharing platform includes a software tool referred to herein as a “sharing readiness predictor.” The sharing readiness predictor objectively analyzes documents stored on the sharing platform, identifies documents “ready to be shared,” and presents sharing recommendations through UI tools of the sharing platform to encourage users to share their documents.

While a document's “readiness to be shared” is traditionally a subjective evaluation made by the author, the herein disclosed sharing readiness predictor implements fully objective techniques to predict document sharing readiness. In various implementations, these objective techniques rely on pattern-detection within document revision history data and/or machine learning algorithms trained to detect document features indicating that the documents are nearing a defined stage of their development, such as first draft or completion.

In one implementation, the sharing readiness predictor objectively evaluates certain features of a document each time the document is updated and saved in an effort to identify patterns tending to indicate that the is nearing completion and/or that the document is ready to be shared to a limited audience. For example, if the user's recent revision history indicates the user is making very minor edits to the text of a long document, this may indicate that the author is finalizing the document and/or is “stuck” and at a point where input from a limited circle (e.g., the author's team members) may potentially provide the author with incentive to finalize the document. In other implementations, the sharing readiness predictor assesses sharing readiness by jointly analyzing collections of features of a document and comparing those features to like-features of already-shared documents (e.g., in a machine learning model training dataset). In scenarios where the analyzed document features satisfied predefined readiness criteria, the sharing readiness predictor generates a sharing recommendation. For example, a sharing recommendation may be presented to a user through a UI of the sharing platform or by other means such as by sending the user an email or message through a messaging app.

For example, a sharing recommendation may take on the form of an encouraging notification or message with a prompt, such as “it looks like Section III of your document is nearing completion and may be ready for team input. Would you like to share with your team members?” Or: “you started drafting this document over 2 years ago, and it appears ready for publication. Would you like to publish now? In various implementations, the sharing readiness predictor may generate sharing recommendations for entire documents and/or limited section(s) of documents that satisfy evaluated readiness criteria.

Since the disclosed sharing recommendations are designed to be presented in limited circumstances for documents that exhibit characteristics indicative of sharing readiness, a user is likely to be presented with a sharing recommendation around the same time that the user is also feeling that the document is “nearly” ready to be shared. The recommendation may therefore serve as a form of assurance to the author that the document is indeed satisfactory enough to be shared, thereby giving the user the confidence to publish the comment and/or solicit team comment/input when the user otherwise may have chosen to “sit” on the document for a few more rounds of revision and/or indefinitely. Likewise, a sharing recommendation that includes a sharing prompt simplifies the physical steps that the author would otherwise need to take to achieve the same (e.g., the user clicks “yes, share” on the prompt and is presented with a menu full of sharing options that the user may otherwise have to take one or more burdensome, independent actions to navigate to and select).

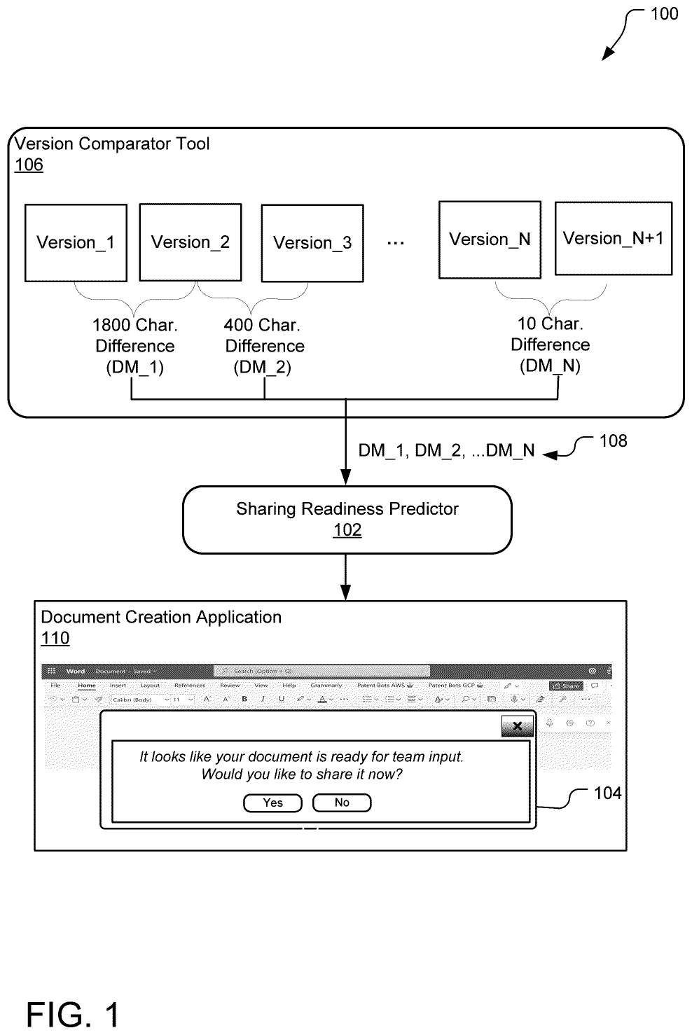

FIG. 1 illustrates features of an example web-based document creation and sharing platform (“sharing platform 100”) that auto-assesses documents for sharing readiness and auto-generates intelligent sharing recommendations. The sharing platform 100 hosts one or more document creation applications (e.g., a document creation application 110) and provides interface features that facilitate multi-user collaboration on documents created within such application(s). The sharing platform 100 may additionally provide for centralized document storage, such as on a cloud-based server of the sharing platform 100. One example of a web-based document creation and sharing platform is Office 365®, which provides access to web-based interfaces for document creation applications such as Word®, Excel®, and Outlook®.

The sharing platform 100 includes a sharing readiness predictor 102 that receives as input certain document features (e.g., inputs 108), evaluates the received document features in view of predefined readiness criteria, and selectively outputs a sharing recommendation 104 responsive to determining that the received revision history features satisfy the readiness criteria.

In FIG. 1, the sharing readiness predictor 102 is shown receiving certain revision history features of a document. Revision history features include information pertaining to document modifications that are made in association with each of multiple consecutively-saved versions of the document. In FIG. 1, a version comparator tool 106 compares different (e.g., consecutively-saved) versions of a same document to determine one or more metrics, referred to herein as “deviation metrics.” The term “deviation metric” is used in the following description to reference a metric that characterizes the differences in content included in different versions of a document. In some implementations, the deviation metrics disclosed herein characterize content difference that are detectable across consecutively-saved versions of a document.

The deviation metrics provided to the sharing readiness predictor 102 characterize may, in various implementations, characterize different types of content discrepancies and/or measure content discrepancies in different ways. In one such implementation, a document's revision history is used to detect and track different types of document changes, such as number of modifications, additions, subtractions, etc. For example, tracked revision history statistics may indicate that 1200 characters were changed between version 1 and version 2 of a document and that of these 1200 characters modified, 900 characters were newly added in version 2 while another 300 characters were removed. Still other implementations may provide for tracking revision history statistics with respect to individual sections of a document in addition to and/or in lieu of tracking such statistics for the document as a whole (e.g., 400 characters were changed in section I, version II of the document; 2 characters were changed in section II, version II of the document). In another implementation, a document (or portions of a document) are encoded as embeddings and different versions of the document (or portions thereof) are semantically compared by measuring the cosine similarity or dot product between their respective embeddings.

Although the examples provided herein pertain primarily to the above-provided examples of deviation metrics, one of skill in the can appreciate that there exist a variety of suitable mathematical schemes for comparing datasets that can be similarly used to characterize similarities and/or differences across different versions of a document. By example, other deviation metrics suitable for implementation within the sharing readiness predictor 102 include measurements of Jaccard distance, Euclidean distance, Hamming distance, the Sorenson-Dice index, Levenshtein distance, and Ratcliff/Obershelp Pattern Recognition (Gestalt Pattern Matching).

In various implementations, any of the above metrics and/or similar metrics not mentioned may be employed individually or in combination to measure version-to-version document similarity and thereby predict whether the document is still evolving or is nearing completion (e.g., whether “readiness criteria” have been satisfied).

In FIG. 1, the version comparator tool 106 computes a deviation metric for each pair of consecutively-saved versions of document. The deviation metric is, for example, a difference in total characters (additions+deletions) between the two versions. By example, the notation “DM_1, DM_2, . . . DM_N” is used throughout to indicate deviation metrics computed or otherwise determined with respect to pairs of consecutively-saved versions of a document in a series of consecutively-saved versions of the document. For example, DM_1 characterizes a similarity between versions 1 and 2, DM_2 characterizes a similarity between versions 2 and 3, and DM_N characterizes a similarity between versions N and N+1.

The sharing readiness predictor 102 receives certain features of the document as inputs 108 and evaluates whether or not the received document features satisfy predefined readiness criteria. In FIG. 1, the sharing readiness predictor 102 receives certain revision history features, including the above-described deviation metrics that each individually characterize content differences between two consecutively-saved versions of the document.

Although some implementations of the sharing readiness predictor 102 render sharing recommendations exclusively based on such revision history features, still other implementations render sharing recommendations based on other types of document features in addition to and/or in lieu of revision history features. For example, the sharing readiness predictor 102 may receive as input document features pertaining to document age, document type (e.g., “type” being an article, technical specification, thesis, or other type setting configured by the author or inferred based on document content), author identifier, collaborator identifiers, number of times the document has been revised, document length features (e.g., number of words or sentences in the document or its individual sections), etc.

While different implementations may utilize different readiness criteria to evaluate the inputs 108 (e.g., various features of the document being evaluated), the implementation of FIG. 1 evaluates readiness criteria by performing trend-detection actions with respect to the received series of deviation metrics in the inputs 108. Trend-detection actions include actions for detecting patterns in the received inputs 108 (e.g., deviation metrics and/or revision history data for the document). For example, the number of edits to each newly-saved version of a document may taper off as the document nears completion. Likewise, the nature of the edits may trend from more to less substantive. For example, edits to an early draft of a document may include additions of large sections of text while edits to a draft nearing completion may largely consist of minor word-smithing revisions (e.g., minor word changes, insertions, rewording).

In one implementation, the sharing readiness predictor 102 evaluates the predefined readiness criteria by comparing one or more deviation metrics to a defined threshold. For example, a document may be ready for sharing when deviation metrics corresponding to consecutive versions of a document follow some trend—such as dropping below a threshold, rising above a threshold, or satisfying similarity criteria (e.g., indicating that the document is not changing much).

In one implementation, the sharing readiness predictor 102 evaluates the predefined readiness criteria by determining whether “substantial convergence” is observed with respect to values of a deviation metric repeatedly computed for a consecutively-saved versions of the document. A deviation metric is herein referred to as having “substantially converged” over different versions of a document when the values of the metric converge to within a predefined threshold margin (e.g., +/−10% or other defined range) of a convergence value. For example, a rate of revision may, over multiple versions of document, substantially converge to within +/−10% of a fixed value.

In still other implementations, the sharing readiness predictor 102 determines that the predefined readiness criteria is satisfied when certain features of the document (e.g., revision history features alone or in combination with other document features) satisfy a determined similarity with documents previously shared by the author or others. For example, the sharing readiness predictor 102 may include one or more trained machine learning models to evaluate the predefined readiness criteria (e.g., AI-detectable document similarities).

Responsive to determining that the inputs 108 (document features) satisfy readiness criteria, the sharing readiness predictor 102 communicates with a document creation application 110 on the sharing platform 100, such as by invoking an API call that causes a sharing recommendation 112 to be displayed in a graphical user interface (GUI) of the application, such as at a time when the author editing the document that has been evaluated for sharing readiness. For example, the sharing recommendation 112 is in the form of a prompt that says: “It looks like your document is ready for team input. Would you like to share it now?” Upon selecting “share,” the user may be presented with further options that allow the user to select users to share the document with and/or a method for notifying such users (e.g., creating a link to the document that the user can share, automatically emailing the selected users a link to the document).

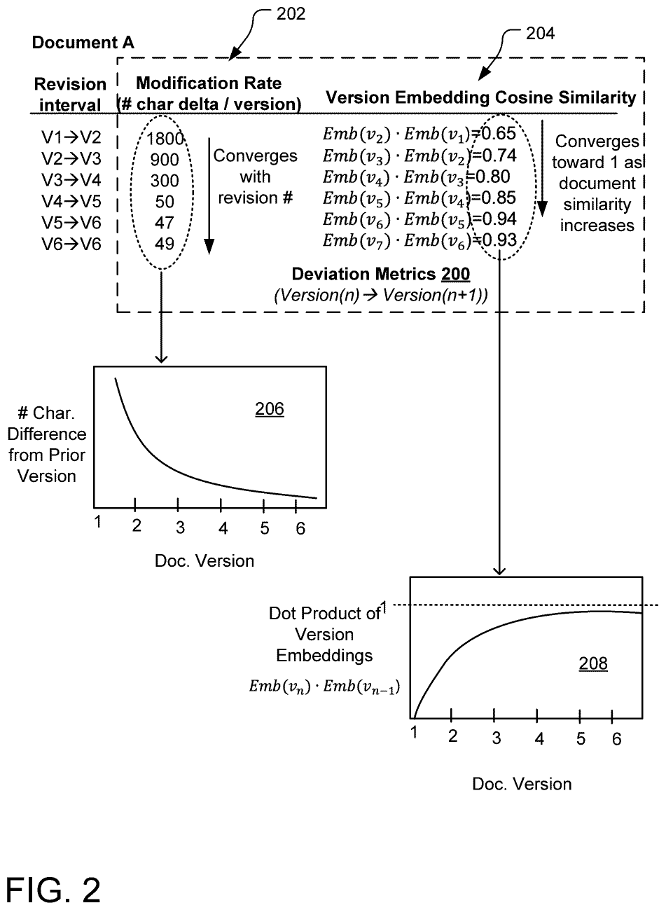

FIG. 2 illustrates example deviation metrics 200 computed for different versions (v1, v2 . . . v6) of an in-progress document that are usable to evaluate document sharing readiness. As the document nears completion, the deviation metrics exhibit detectable trends. With awareness of these expected trends, the deviation metrics 200 can be computed for any version of the document and the resulting value(s) can be used to intelligently predict whether the document is almost finished and/or ready to be shared. Specifically, the deviation metrics 200 include (1) a measured document modification rate 202 and (2) a cosine similarity 204 of embeddings generated from different versions of a document.

In one implementation, a document sharing platform with a sharing readiness predictor, such as the sharing readiness predictor 102 of FIG. 1, computes one or more of the deviation metrics (e.g., 202, 204) for each of multiple consecutively-saved versions of a document. From these computed deviation metric values, the sharing readiness predictor predicts a likelihood that the document will be subjected to further substantive changes. When that likelihood is deemed “low” the sharing readiness predictor renders a sharing recommendation. To determine this likelihood of additional future changes to the document, the sharing readiness predictor assesses the computed deviation metric value(s) in view of “readiness criteria,” which may in various implementations include predefined policies or rules set forth with respect to static thresholds and/or dynamically-generated rules and/or thresholds used for comparison to the computed values.

The modification rate 202 is one example of a deviation metric that may be used to predict a document's likelihood of being changed further and/or to predict the rate or type of future changes to the document. In FIG. 2, the illustrated modification rate 202 corresponds to a character-delta per revision (e.g., number of total characters that are different in two consecutively-saved document versions). FIG. 2 illustrates a trend in the modification rate 202 for example Document A in which the character delta steadily decreases throughout the first few revisions and, in time, substantially converges to a set value. While the values provided for the modification rate 202 are purely exemplary, this type of convergence trend may be generally true of a large number of documents—e.g., the document is subjected to more substantive changes the first few times it is opened and edited and, in time, these changes taper off and become more less substantive. “More substantive changes” includes, for example, additions of large blocks of text while “less substantive changes” include word-smithing changes and minor additions/deletions.

As shown in plot 206, the values for the modification rate 202 corresponding to the most recent versions of the document substantially converge to within +/−a threshold margin (e.g., +/−10%) of a convergence value (e.g., a 49-50 character delta per revision).

In one implementation, a sharing readiness predictor analyzes modification rates computed for pairs of consecutively-saved versions of a document (as shown) and renders a sharing recommendation responsive to detecting substantial convergence of the collected time-consecutive modification rate values. In another implementation, the sharing readiness predictor renders a sharing recommendation responsive to determining that a modification rate for a most recently-saved version of a document has dropped below a predefined threshold (e.g., a character delta that is less than 5% the length of the total document). In still another implementation, the sharing readiness predictor renders a sharing recommendation responsive to determining that a group of the modification rates corresponding to the most recently-saved versions of satisfy predefined readiness criteria (e.g., the most recent 3 modification rates substantially converge or average a value below a set threshold).

The cosine similarity 204 of version embeddings is another deviation metric usable to predict document readiness. Like the modification rates 202, the version embedding cosine similarity is computed from a document's revision history data. According to one implementation, each version of a document (e.g., Document A) is encoded as one or more high dimensional vectors (embeddings) within a vector space created by a natural language processing (NLP) model. Within this vector space, the distance between each pair of the embeddings corresponds with similarity between the associated embedded content. If, for example, version 1 of Document A is embedded as a first vector, Emb(v1), and version 2 of Document B is embedded as a second vector, Emb(v2), the cosine similarity is defined as the angle between Emb(v1) and Emb(V2). In general, the cosine similarity of two vectors approaches 1 as the two vectors become increasing similar. In the example of FIG. 2 where there are fewer and fewer changes with each subsequent version of Document A, the cosine similarity substantially converges toward 1 as the document nears completion. Example NLP models capable of creating embeddings of this type include sequence-to-sequence (Seq2Seq) models or transformer models, such as BERT (Bidirectional Encoder Representations from Transformers). In some implementations, the deviation metrics 200 include a dot product (rather than a cosine similarity) of embeddings corresponding to different versions of a document.

As shown in plot 208, the last few computed cosine similarity terms substantially converge to within +/−a threshold margin (e.g., 10%) of a convergence value (e.g., 1). In one implementation, the sharing readiness predictor 202 analyzes cosine similarities computed for pairs of consecutively-saved versions of a document and renders a sharing recommendation responsive to detecting substantial convergence of the computed cosine similarity terms in the past few terms of the time-consecutive series. In another implementation, the sharing readiness predictor 202 renders a sharing recommendation responsive to determining that a computed cosine similarity has exceeded a set threshold (e.g., 0.90). In still another implementation, the sharing readiness predictor 202 renders a sharing recommendation responsive to determining that a group of the computed cosine-similarity terms corresponding to the most recently-saved versions of the document substantially converge or average a value below a threshold.

Notably, the use of version embeddings is an effective way to differentiate between semantic shifts (e.g., changes to content) and other types of changes that do not substantively change the content of the document. For example, a spell check of a large document might lead to many changes (e.g., a high modification rate) without changing the substantive content of the document. In contrast, measuring the similarity of version embeddings—such as by dot product or cosine similarity—effectively measures the substantive changes to the document (semantic shifts) without inadvertently also measuring minor spelling and grammatic edits. When a document is nearing completion, the similarity of version embeddings is typically high (meaning there is little semantic difference) as shown in the plot 208. While the modification rate trend (as shown in 206) is generally predictable, it may be more vulnerable to single-point anomalies, such as when a user spellchecks a nearly-completed document and the modification rate jumps to a high level. Therefore, it may be advantageous in some instances to rely on a similarity measurement of version embeddings in lieu of or in addition to modification rate.

Notably, some implementations provide for computing one or more different types of deviation metrics (e.g., modification rates for document additions/deletions/net changes, cosine similarities, dot products) and/or for computing such metrics with respect to different individual sections. If, for example, the sharing readiness predictor determines that the deviation metric has substantially converged with respect to a particular section of the document, the sharing readiness predictor may render a section-specific sharing recommendation such as (“it appears that section II is nearing completion. Would you like to open this section to your team for comments?)

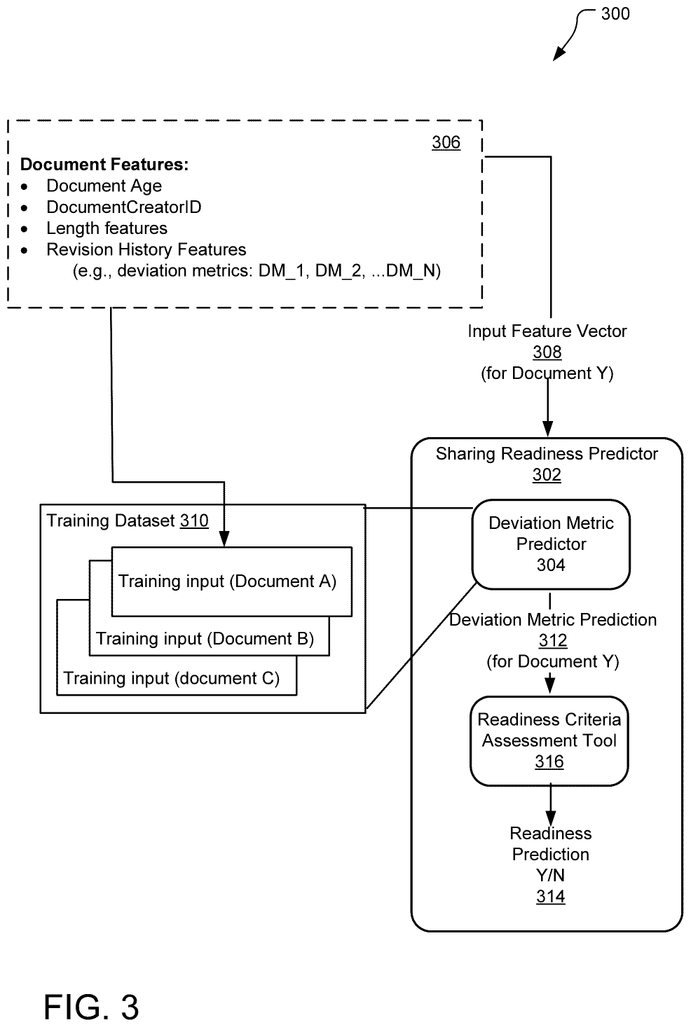

The examples of FIG. 2 generally illustrate how the deviation metrics 200 (computed from a document's past revision history data) can be indicative of sharing readiness. Notably, the deviation metrics discussed with respect to FIG. 2 may follow slightly different trends for different types of documents with different characteristics. For example, certain deviation metrics computed for a class of longer documents (e.g., books) may converge more slowly than the same deviation metrics computed for shorter documents (e.g., articles). By identifying more general similarities between different documents with diverse characteristics, more intelligent (predictive) inferences can be drawn from the document's deviation metrics. Consistent with this premise, FIG. 3 illustrates an expansion of the concepts discussed with respect to FIG. 2 that employs machine learning techniques to intelligently predict a future deviation metric or a trend in a set of deviation metric values for a given document. For example, an AI model may intelligently predict whether (and by how much) a document is likely to be changed over a future time interval. If the document is not likely to be changed much, this may be an indicator that the document is ready for sharing.

FIG. 3 illustrates a sharing platform 300 with a sharing readiness predictor 302 that predicts document sharing readiness based on predictive outputs generated by a deviation metric predictor 304. In the example shown, the deviation metric predictor 304 receives an input feature vector 308 including characteristics of a document that is to be analyzed for readiness (“Document Y”). Based on the input feature vector 308 and logical associations derived from a training dataset 310, the deviation metric predictor 304 generates a deviation metric prediction 312. For example, the deviation metric prediction 312 may be a predicted rate of modification over a future time interval, a predicted shift in cosine similarity of version embeddings over a future time interval, or a predicted trend in a sequence of deviation metrics corresponding to different consecutively-saved versions of document Y (e.g., a predicted rate of convergence for the deviation metric).

The input feature vector 308 includes a collection of document features 306 that may vary in number of form in different implementations. Example document features 306 include document age, DocumentCreatorlD (e.g., identifying the author of the document), one or more length features (e.g., number of words, number of sentences, number of sections, etc.), and revision history features (e.g., number of saved versions and/or deviation metrics the same or similar to those discussed with respect to FIG. 2). These features are intended to be exemplary and the input feature vector may in some implementations include other features in addition to or in lieu of one or more of the features listed above.

In FIG. 3, the deviation metric predictor 304 is a machine learning model trained on a training dataset 310 that includes a feature vector for each of a number of documents in a training dataset 310 (e.g., Document A, Document B, Document C). In one implementation, training inputs for each document in the training dataset 310 includes a feature vector and a deviation metric vector (e.g., [FeatureVector, DeviationMetricVector]), each of which are multi-dimensional. The feature vector includes select features of the document (e.g., age, length, creatorlD) and the deviation metric vector includes a sequence of deviation metrics computed for pairs of consecutively-saved versions of the document, such as in the manner shown and described with respect to FIG. 2. Assuming that the input feature vector 308 (for Document Y) includes the same types of data as the feature vector provided for each document in the training dataset 310, the deviation metric predictor 304 can utilize logical associations (e.g., feature similarities, dissimilarities) derived from the training dataset 310 to predict a corresponding deviation metric vector for document Y. Stated differently, the deviation metric predictor 304 can predict the shape of the curves shown in plots 206, 208 in FIG. 2.

For example, the training inputs for document A may include (1) a feature vector of the form [DocumentAge, DocumentCreatorlD, length of document, number of words] and (2) a deviation metric vector including a sequence of deviation metrics of the form [DM_1, DM_2, . . . DM_N], where this notation has the same meaning as described above with respect to FIG. 2). Given these two types of vectors for each document in a large training dataset and given the input feature vector 308 for Document Y that is of the same form as (1) described above, the deviation metric predictor 304 is able to generate a predicted deviation metric vector for Document Y of the same form as (2) above. The deviation metric prediction 312 is, in some implementations, usable to infer a rate of convergence for the deviation metric of Document Y (e.g., an indicator of document readiness for sharing).

Likewise, in another implementation, the deviation metric predictor 304 receives, for each version of each document in the training dataset 310, a pair of vectors of the form [VersionFeatureVector, DeviationMetricValue]. Here, “VersionFeature Vector” is a multi-dimensional vector including features specific to a particular version of the document while “DevationMetricValue” is a deviation metric computed in association with that version e.g., as shown and described with respect to FIG. 1 and v1, v2, v3, etc. For example, each VersionFeatureVector may include one or more version-specific document features such as the length of the version, the age of version at the time it was saved, the number of sections in version, etc. In this implementation, the input feature vector 308 for document Y is of the same form (including the same fields) as the VersionFeatureVector. In this implementation, the deviation metric predictor 304 outputs a single predicted deviation metric value for the current version of Document Y (e.g., a predicted rate of change over the next 2 months) as the deviation metric prediction 312.

In either of the above-described implementations, a readiness criteria assessment tool 316 determines whether the deviation metric prediction 312 (e.g., a multi-dimensional deviation metric vector or single deviation metric) satisfies predefined readiness criteria and outputs a Y/N readiness prediction 314. If the readiness prediction is “Y” (e.g., yes, the document is ready for sharing), the sharing readiness predictor 302 outputs a sharing recommendation, such as in the manner described above with respect to FIGS. 1 and 2.

While FIG. 3 illustrates modeling solutions for predicting one or more deviation metrics (e.g., rate of change before and after next revision) for a document based on similarities between the document and other documents, it is of note that the above description of FIG. 3 assumes that the readiness criteria assessment tool 316 is equipped with a predefined set of “readiness criteria” that is useable to determine whether or not a particular computed or predicted deviation metric is indeed indicative that the document ready for sharing. Likewise, the above description of FIG. 2 also assumes that the computed deviation metrics can be evaluated against a set of predefined readiness criteria to determine whether an associated document is ready for sharing.

While it is possible to define “readiness criteria” in the form of hard-coded policies and rules—e.g., a policy providing that the document is ready to be shared when the deviation metric drops below a set threshold or has 3 or more consecutive values within +/−10% of one another (e.g., substantial convergence), still other implementations of the disclosed technology provide for modeling—for each individual document—the readiness criteria that, when satisfied, is indicative of document-sharing readiness. This class of solutions seeks to use AI to answer the question: “which deviation metric values and/or characteristics indicate that a particular document is ready to be shared?”

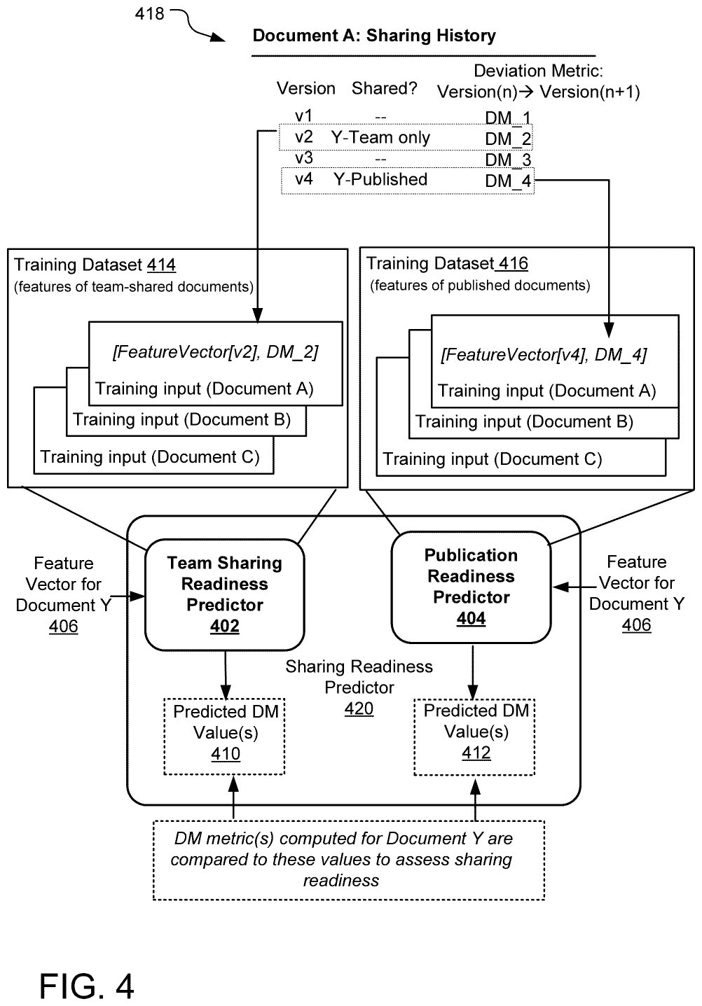

FIG. 4 illustrates an example intelligent sharing recommendation system 400 that uses sharing history data of documents previously shared on a sharing platform to train AI to predict criteria usable to evaluate whether a particular document is ready for sharing. Whether or not a document is “ready to be shared” is traditionally a subjective assessment performed by the author of the document; however, this subjective assessment can be objectively performed by an AI model trained on a dataset that includes actual using sharing history for various documents, to differentiate between documents that users are likely to perceive as either “ready” to be shared or “not ready” to be shared.

Notably, it is common for an author to share a document in two different ways at two different states of its development. First, an author may send an early draft of a document to their team (coworkers, colleagues) for comment. After revising the document further to incorporating these team-provided comments, the author may publish the document to a wider audience such as their entire organization or for submission to a publication source. These two types of sharing are referred to herein as “team sharing” and “publication.” As used herein, “team sharing” or “sharing at the team level” refers to sharing with an author-selected limited group of individuals, such as the author's teammates or a few select work colleagues. In contrast, “publication” or “sharing by publication” is used herein to refer to a release of a final version of the document to a wider audience that is not directly restricted by the author. For example, an entity-internal reference document is considered published when it is released at a read-only access level to all individuals employed by the entity. Likewise, publication may entail listing a document is a searchable database or actual publication in a periodical.

The intelligent sharing recommendation system 400 includes a sharing readiness predictor 420 that includes two different machine learning models— (1) a team sharing readiness predictor 402 and (2) a publication readiness predictor 404. The team sharing readiness predictor 402 is trained on actual “team sharing” history of various documents to predict a deviation metric (DM) value 410 usable to evaluate whether or not a particular document is ready for team sharing. Likewise, the publication readiness predictor 404 is trained on actual publication history of various documents to predict a DM value 412 usable to evaluate whether or not a particular document is ready for publication.

The predicted DM value 410, 412 output by the team sharing readiness predictor 402 and the publication readiness predictor 404, respectively, are usable to evaluate the “readiness criteria” as discussed elsewhere herein. For example, the readiness criteria assessment tool 316 of FIG. 3 may compare deviation metric(s) for the document being evaluated (Document Y) to the predicted DM value 410 or the predicted DM value 412 and, if the two compared values satisfy similarity criteria (e.g., they are separated by less than a predefined threshold), this may suffice to trigger generation of a sharing recommendation.

The team sharing readiness predictor 402 is trained on a training dataset 314 while the publication sharing readiness predictor 404 is trained on a training dataset 316. The training datasets 414, 416 are similar in structure. Assume, for example, that features of Document A, Document B, and Document C are included in both of the training datasets 414 and 416.

Each of documents A, B, and C have a saved, accessible sharing history. For example, view 418 illustrates example sharing history data for document A. As shown, version 1 of Document A was never shared; version 2 f Document A was shared at the team level; version 3 was not shared and (v4) was published.

The training datasets 414 and 416 each include a training input of the form [FeatureVector, Deviation Metric] for each different one of Documents A, B, and C. However, the training dataset 414 includes these inputs for versions of documents shared at the team level while the training dataset 416 includes these inputs for other versions of the same documents that were published. In the example shown, the training dataset 414 for the team sharing readiness predictor 402 therefore includes a feature vector for version 2 of Document A and a deviation metric computed in association with version 2 (e.g., characterizing differences between version 1 and version 2, as described with respect to FIG. 2). The feature vector may, for example, include document features such as age of the version, features characterizing length of the version, features characterizing content of the version, etc. Other documents in the training dataset 414 include the same types of data for other versions of documents that were shared at the team level.

Likewise, the training dataset 416 for the publication readiness predictor 404 includes a feature vector for version 4 of Document A (e.g., the version that was actually published) and a deviation metric computed in association with version 4. Other documents in the training dataset 464 include the same types of data versions of other documents that were published.

In FIG. 4, the team sharing readiness predictor 402 receives as input a feature vector 406 for a current version of “Document Y”— a document that is to be evaluated for sharing readiness. The feature vector 406 may be understood as including document features the same or similar to those described above with respect to FIG. 3 and that are of the same or similar form to those feature vectors included in each of the training inputs in the training datasets 414, 416.

In the example of FIG. 4, the team sharing readiness predictor 402 outputs the predicted DM value 410 that is usable to evaluate sharing readiness of Document Y. The predicted DM value 410 is derived, by the team sharing readiness predictor 402, from revision history features of documents in the training dataset 414 that are identified (by the model) as most similar to Document Y. If, for example, Document Y is a technical publication, the predicted DM value 410 may be a deviation metric computed with respect to versions of similar technical publication in the training dataset 314.

For example, the sharing readiness predictor 420 determines that Document Y is ready for sharing at the team level when the predicted DM value 410 satisfies similarity criteria with (1) a deviation metric computed from the revision history data of document Y or (2) a deviation metric predicted for document Y, such as a deviation metric output by the deviation metric predictor of FIG. 3. In one implementation, the sharing readiness predictor 420 determines (compute or otherwise obtains) deviation metric(s) for past saved revisions of Document Y. If the determined deviation metric(s) are within a predefined threshold of the predicted DM value 410, the sharing readiness predictor 420 determines that Document Y is ready for team sharing and generates a team sharing recommendation (e.g., “Would you like to share this document with your team members now?). This recommendation may be presented to the author of Document Y in a manner consistent with that described above with respect to FIG. 1.

In a similar fashion, the publication readiness predictor 404 receives as input the feature vector 406 for Document Y—e.g., the document that is to be evaluated for publication readiness. The publication readiness predictor 404 outputs the predicted DM value 412 that is usable to determine whether Document Y is ready for publication. For example, the predicted DM value 412 may be a deviation metric value that, when observed in the revision history data for Document Y (or reasonably predicted, such as by the deviation metric predictor of FIG. 3), indicates that the document is ready for publication.

The sharing readiness predictor 420 uses the readiness criterion 412 to determine whether Document Y is ready for publication. For example, the sharing readiness predictor determines (compute or otherwise obtains) deviation metric(s) for past saved revisions of Document Y. If the determined deviation metric(s) are within a predefined threshold of the readiness criterion 412, the sharing readiness predictor 420 determines that Document Y is ready for team sharing and generates a team sharing recommendation (e.g., “Would you like to publish this document now?). This recommendation may be presented to the author of Document Y in a manner consistent with that described above with respect to FIG. 1.

Features of the sharing readiness predictor 420 not explicitly described with respect to FIG. 4 may be assumed the same or similar to like-named components described herein with respect to other implementations.

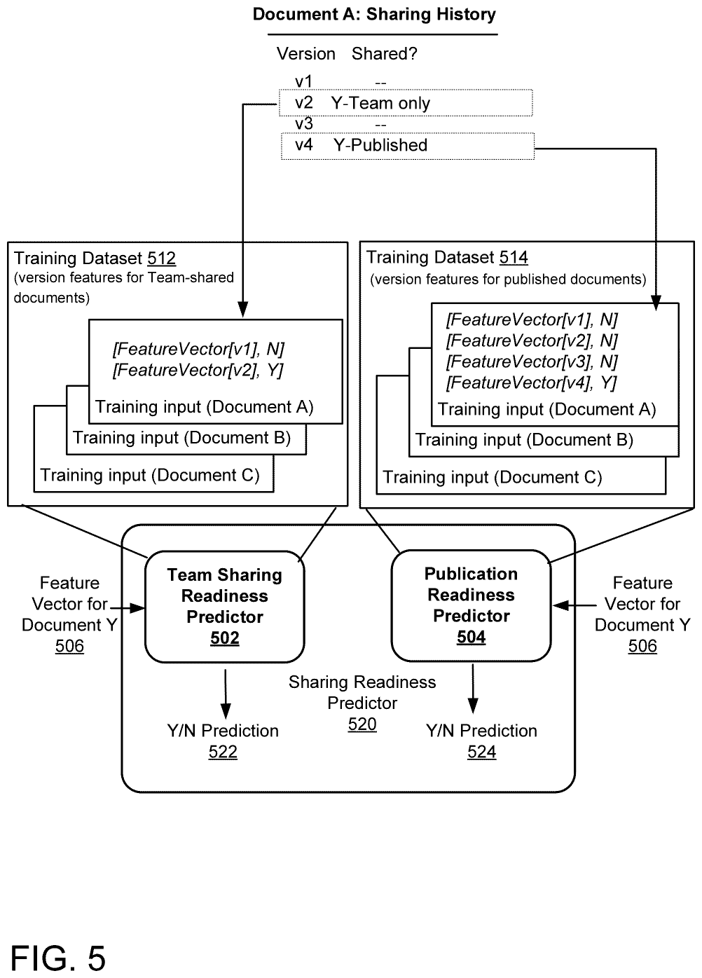

FIG. 5 illustrates yet another example intelligent sharing recommendation system 500 that uses sharing history data of documents previously shared on a sharing platform to train an AI to generate intelligent sharing recommendation. The AI models of FIG. 5 differ from FIG. 4 in their respective outputs. The AI models of FIG. 4 output “readiness criteria” used to evaluate readiness (a further affirmative step performed by software); in contrast, the AI models of FIG. 5 output a “Yes” or “No” prediction indicating that the document is ready for sharing.

The intelligent sharing recommendation system 500 includes a sharing readiness predictor 520 that includes two different machine learning models— (1) a team sharing readiness predictor 502 and (2) a publication readiness predictor 504. The team sharing readiness predictor 502 and the publication readiness predictor 504 are trained on training datasets 512 and 514, respectively. In the example shown, features of Document A, Document B, and Document C are included in both of the training datasets 514 and 516.

Each of Documents A, B, and C have a saved, accessible sharing history. For example, view 518 illustrates example sharing history data for Document A. As shown, version 1 of Document A was never shared; version 2 of Document A was shared at the team level; version 3 was not shared, and (v4) was published.

For each document in the training dataset 514, training inputs include a feature vector for the version shared at the team level along with a binary indicator “Y” indicating that this version was shared. The training inputs additionally a feature vector for each previous version that was not shared at the team level along with a binary indicatory “N” indicating that these versions were not shared at the team level.

Likewise, training inputs for each document included in the training dataset 516 include a feature vector for the version that was published along with a binary indicatory “Y” indicating that this version was published. Additionally, a feature vector is included for each unpublished version of the same document along with a binary indicator “N” indicating that these versions were not published.

In FIG. 5, the team sharing readiness predictor 502 receives as input a feature vector 506 for a current version of “Document Y”— a document that is to be evaluated for sharing readiness. The feature vector 506 may be understood as including document features the same or similar to those described above with respect to FIG. 3 and that are of the same or similar form to those feature vectors included in each of the training inputs in the training datasets 512, 514. The team sharing readiness predictor 502 outputs a binary (Y/N) indicator 522 that is predictive of whether or not the document is ready to be shared at the team level (e.g., based on similarity between the feature vector of Document Y and the feature vectors for versions of other documents that were shared at the team level). When the binary indicator 522 is a “Y”, the sharing readiness predictor 520 determines that the readiness criteria is satisfied. Responsive to this determination, the sharing readiness predictor 520 generates a sharing recommendation that is presented to the author of the document through a user interface of an application that the author uses to edit Document Y (e.g., within a sharing platform hosting the intelligent sharing recommendation system 500).

Similarly, the publication readiness predictor 504 receives as input the feature vector 506 for the current version of “Document Y”— a document that is to be evaluated for sharing readiness and outputs a binary (Y/N) indicator 524 that is predictive of whether or not the document is ready to be published (e.g., based on similarity between the feature vector of Document Y and the feature vectors for versions of other documents that were published). When the binary indicator 524 is a “Y”, the sharing readiness predictor 520 determines that the readiness criteria is satisfied. Responsive to this determination, the sharing readiness predictor 520 generates a sharing recommendation that is presented to the author of the document through a user interface of an application window displaying Document Y.

In some implementations, the training datasets shown in the AI models of FIGS. 3, 4, and 5 may include or consist exclusively of other documents authored by the same user as the document being evaluated for readiness. This may be useful particularly for prolific authors that frequently share with teams and/or publish and that may have particular sharing preferences—e.g., perhaps the individual prefers to share documents with one of his teammates when the documents are at an earlier drafting phase than the phase characteristic of other documents shared by others at the team level (e.g., preliminary rough draft phase v. solid rough draft phase). In other implementations, the training datasets used by the various models disclosed herein include documents authored by a diverse body of individuals. Likewise, some implementation may rely on training sets that consist of documents satisfying some other similar characteristic—e.g., they are all of the same document type, by authors affiliated with a same organization, or other commonality. The selection of documents included in each training dataset is a matter of design choice, and it is generally known that AI predictive capability improves in proportion to the degree of similarity between components represented in a model training set and the component the model is used to render a prediction for.

Features of the sharing readiness predictor 520 not explicitly described with respect to FIG. 5 may be assumed the same or similar to like-named components described herein with respect to other implementations.

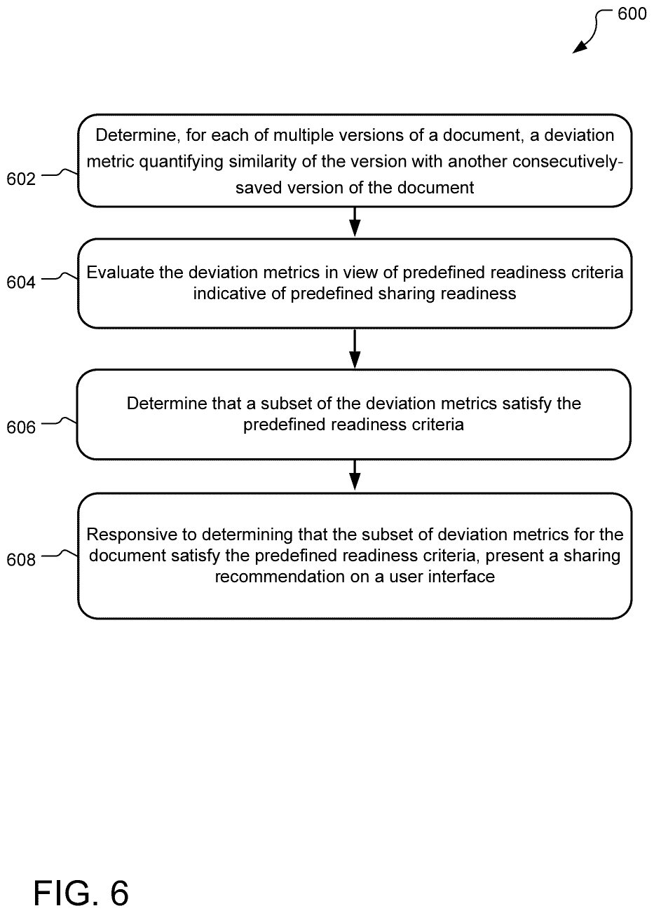

FIG. 6 illustrates example operations 600 for intelligently generating sharing recommendations for documents created and shared on a web-based sharing platform. A determining operation 602 determines for of multiple versions of a document a deviation metric quantifying similarity of the version with a consecutively-saved version of the document (e.g., an immediately prior-saved version or a next-saved version). For example, the deviation metric may be a rate of change for the document (e.g., total characters or word changed between two consecutive revisions) or a measured similarity between embedding representations of consecutively-saved versions of the document (e.g., a cosine similarity or dot product).

An evaluation operation 604 evaluates the deviation metrics in view of predefined readiness criteria indicative of sharing readiness. For example, the evaluation operation 604 may evaluate whether or not the deviation metrics for consecutively-saved versions of the document substantially converge and/or satisfy other criteria such as dropping above or below a preset threshold. In still another implementation, a machine learning model (e.g., the team sharing readiness predictor 402 or publication readiness predictor 404) evaluates the deviation metrics for the document in view of document features of other documents stored on the web-based sharing platform. From this evaluation, the machine learning model generates a predictive value (e.g., a convergence value or threshold) that is usable to evaluate the readiness criteria. For instance, the machine learning model may predict that a first document (e.g., a novel) is ready to share when the modification rate drops below 500 characters per revision and/or that a second document (an article) is ready to share when the modification rate drops below 50 characters per revision.

A determination operation 606 determines that a subset of the deviation metrics for document satisfy the predefined readiness criteria. For instance, the determination operation 606 may determine that the deviation metrics satisfy the predefined criteria because the time-consecutive sequence of the deviation metrics substantially converges or, alternatively, because the deviation metric for the last-saved version (or a couple of most recent versions) rises above a set threshold or drops below a set threshold.

A recommendation operation 608 presents a sharing recommendation on a user interface responsive to determining that the subset of deviation metrics for the document satisfy the predefined readiness criteria. For example, the sharing recommendation is a prompt asking the user if they would like to select one or more users of the platform to share the document with.

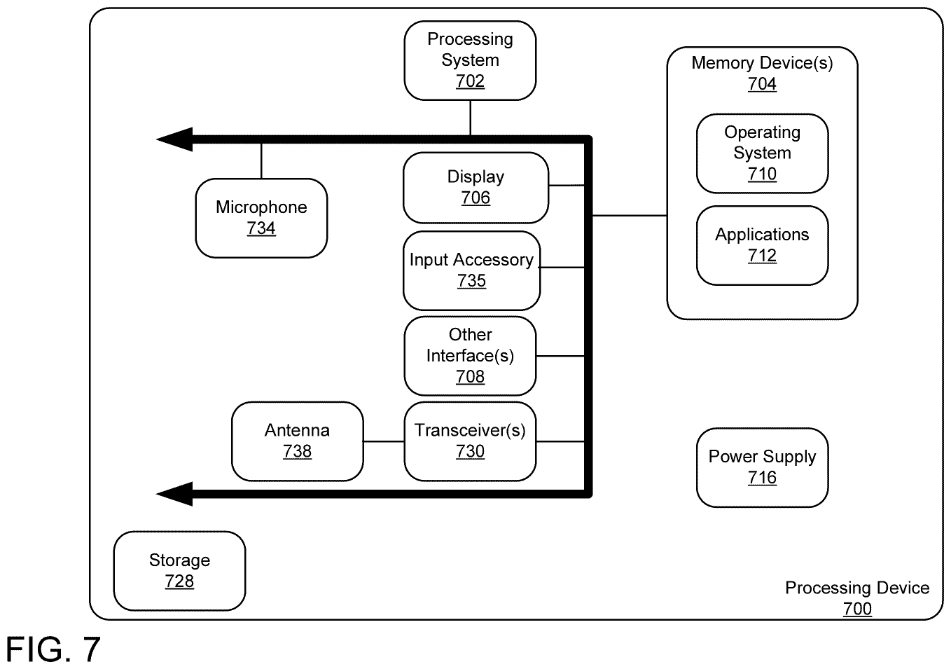

FIG. 7 illustrates an example schematic of a processing device 700 suitable for implementing aspects of the disclosed technology. In one implementation, the processing device 700 provides a user with access to a web-based document creation and sharing platform that generates intelligent sharing recommendations. In other implementation, the processing device 700 is a server that hosts aspects of a document creation and sharing platform.

The processing device 700 includes a processing system 702, memory device(s) 704, a display 706, and other interfaces 708 (e.g., buttons). The processing system 702 may each include one or more CPUs, GPUs, etc. The memory 704 generally includes both volatile memory (e.g., RAM) and non-volatile memory (e.g., flash memory). An operating system 710 may reside in the memory 704 and be executed by the processing system 702.

One or more applications 712 (e.g., a document creation application 110, a sharing readiness predictor 102, 302, 420, 520, a web-browser used to access a web-based document creation and sharing platform) are loaded in the memory 704 and executed on the operating system 710 by the processing system 702. The applications 712 may receive inputs from one another as well as from various input local devices such as a microphone 734, input accessory 735 (e.g., keypad, mouse, stylus, touchpad, gamepad, racing wheel, joystick), and a camera 732.

Additionally, the applications 712 may receive input from one or more remote devices, such as remotely-located smart devices, by communicating with such devices over a wired or wireless network using more communication transceivers 730 and an antenna 738 to provide network connectivity (e.g., a mobile phone network, Wi-Fi®, Bluetooth®). The processing device 700 may also include one or more storage devices 728 (e.g., non-volatile storage). Other configurations may also be employed. The processing device 700 further includes a power supply 716, which is powered by one or more batteries or other power sources and which provides power to other components of the processing device 700. The power supply 716 may also be connected to an external power source (not shown) that overrides or recharges the built-in batteries or other power sources.

The processing device 700 may include a variety of tangible computer-readable storage media and intangible computer-readable communication signals. Tangible computer-readable storage can be embodied by any available media that can be accessed by the processing device 700 and includes both volatile and nonvolatile storage media, removable and non-removable storage media. Tangible computer-readable storage media excludes intangible and transitory communications signals and includes volatile and nonvolatile, removable and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the processing device 600. In contrast to tangible computer-readable storage media, intangible computer-readable communication signals may embody computer readable instructions, data structures, program modules or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include wired media such as a wired network or direct-wired connection, and wireless media such as acoustic, RF, infrared, and other wireless media.

The following summary provides a non-exhaustive set of illustrative examples of the technology set forth herein.

(A1) According to a first aspect, some implementations include a method for intelligently generating a sharing recommendation for a document stored on a sharing platform. The method includes determining, for each of multiple versions of a document saved to the sharing platform, a deviation metric quantifying similarity of the version with another consecutively-saved version of the document; evaluating the deviation metrics for the document in view of predefined readiness criteria indicating the document is nearing completion; and responsive to determining that a subset of the deviation metrics for the document satisfy the predefined readiness criteria, presenting a sharing recommendation on a user interface of the sharing platform.

The method of A1 is advantageous because it allows a computer system to intelligently predict where a document is within the various stages of its lifecycle (e.g., when the document first draft is ready to be shared with a team or when the document is ready to be finalized and published to a wide audience) and render sharing recommendation(s) on that basis that, in turn, advance the given document to completion more quickly than in the absence of such recommendation(s).

(A2) In some implementations of A1, determining that the subset of deviation metrics satisfies the predefined readiness criteria further comprises determining that the subset of deviation metrics for the document substantially converge.

The method of A2 is advantageous because convergence of a deviation metric is indicative that the document is not changing much. This may indicate that the document is either nearing completion or that the user is “stuck” and perhaps could benefit from Team input. In either case, convergence of a deviation metric can trigger a sharing recommendation that boosts user and/or team productivity with respect to the given document.

(A3) In some implementations of A1-A2, the deviation metric includes a rate of modification for the document and determining that the subset of deviation metrics satisfies the predefined readiness criteria further comprises determining that one or more deviation metrics computed for the document is below a threshold.

(A4) In still further implementations of A1-A3, the deviation metric includes a dot product computed with respect to a first embedding corresponding to a select version of the document and a second embedding corresponding to a consecutively-saved version of the document. In this implementation, identifying the subset of the deviation metrics that satisfy predefined readiness criteria further includes determining that the dot product exceeds a predefined threshold.

The methods of A3-A4 provide further methods of intelligently determining where a document is in its lifecycle and of determining whether the document is ready to be shared. By examining thresholds of the above-mentioned deviation metrics that correlate with actual instances of sharing, one can manually or automatically identify and set suitable thresholds for such metrics that are likely to be predictive of sharing readiness.

(A5) In still further implementations of A1-A4, the deviation metric is indicative of a quantity of text that is dissimilar between the version of the document and the consecutively-saved version of the document.

(A6) In yet still further implementations of A1-A5, the method further includes providing features of the document to a readiness predictor trained on a training dataset that includes (1) features of previously-shared documents stored on the sharing platform; and (2) for each of the previously-shared documents, a corresponding computed value for the deviation metric. The method further includes receiving as output from the readiness predictor a predicted value for the deviation metric that is usable to assess sharing readiness of the document; evaluating the predefined readiness criteria by comparing the predicted value for the deviation metric to the deviation metrics determined for the document; and determining that the predefined readiness criteria are satisfied when the predicted value and the subset of deviation metrics determined for the document satisfy predefined similarity criteria.

The method of A6 is advantageous because it allows for intelligent prediction of the readiness criteria (e.g., an intelligent machine-automated determination of which value(s) and/or characteristics of the deviation metric correlate with sharing readiness). Consequently, there is no need for the readiness criteria to be manually determined (e.g., by analyzing large datasets or by other means).

(A7) In still further implementations of A1-A6, the method further includes providing features of the document to a readiness predictor trained on document features for other documents stored on the platform. The document features used to train the readiness predictor include, for each document, revision history data and a binary indicator indicating whether or not the select document was shared. The trained readiness predictor is provided with select features of the document to be assessed for sharing readiness and the model outputs a binary output indicating that the document is or is not ready to be shared.

(A8) According to another aspect, a processor-implemented method for intelligently rendering sharing recommendations for documents stored on a sharing platform includes providing a sharing readiness predictor with features of a first document. The sharing readiness predictor is trained on a dataset document features for multiple versions of multiple documents and, for each version of the multiple versions of each document of the multiple documents, a value indicating whether or not the version of the document was shared. The method further provides for receiving as output from the sharing readiness predictor an indication that the first document is ready to be shared and responsive to receiving the indication, presenting a sharing recommendation.

The method of (A8) offers the same advantages as the method of A1 but additionally eliminates the need for any additional methods (human or machine implemented) for selecting or determining the criteria used to assess whether features of a given document are indicative of sharing readiness. Specifically, the method of A8 uses unsupervised learning techniques to identify correlations between features of a select document and documents that were actually shared and not shared in the training dataset. In this implementation, these AI-identifiable correlations serve as the sharing readiness criteria, and the strength of these correlations provide a basis for AI-evaluation of sharing readiness.

(A9) In further implementations of A8, the document features for the multiple versions of the multiple documents include a deviation metric that quantifies similarity of two consecutively-saved versions of the document. This provides advantages the same or similar to methods A2-A4 described above.

(A10) In still other implementations of A8-A9, the sharing readiness predictor is a team sharing readiness predictor trained on a dataset including the features for multiple versions of multiple documents stored on the sharing platform; and for each version of the multiple versions of each document of the multiple documents, a value indicating whether or not the version of the document was shared at a team level. The sharing recommendation includes a suggestion to share the document at the team level.

The method of A10 is advantageous because it facilitates a determination, by AI, of whether a document is at a stage where it is ready to be shared at the team level (e.g., the document's first draft is completed and/or the author is “stuck” and at the point where team input may be helpful).

(A11) In still other implementations of A8-A10, the sharing readiness predictor is a publication readiness predictor trained on a dataset including the features for multiple versions of multiple documents stored on the sharing platform and, for each version of the multiple versions of each document of the multiple documents, a value indicating whether or not the version was published. The sharing recommendation includes a suggestion to publish the document.

The method of A11 is advantageous because it facilitates an objective determination, by AI, of whether a document is at a stage where it is nearing completion and ready to be published. This objective determination is based on publication history data for documents in a training dataset.

(A12) In still other implementations of A9-A11, the features of the first document provided to the sharing readiness predictor include a value for a deviation metric value quantifying at least one of recent changes to the first document and predicted future changes to the first document.

(A13) In still other implementations of A9-A12, the deviation metric quantifies a modification rate computed with respect to two different versions of the document.

(A14) In still other implementations of A9-A13, the deviation metric quantifies a similarity of embeddings corresponding to different versions of the document. The methods of A13-14 are advantageous for at least the same reasons as A3 and A4 above.

In another aspect, some implementations include a computing system intelligently rendering sharing recommendations for documents stored on a sharing platform. The computing system includes hardware logic circuitry that is configured to perform any of the methods described herein (e.g., methods A1-A14).

In yet another aspect, some implementations include a computer-readable storage medium for storing computer-readable instructions. The computer-readable instructions, when executed by one or more hardware processors, perform any of the methods described herein (e.g., methods A1-A14).

Some implementations may comprise an article of manufacture. An article of manufacture may comprise a tangible storage medium (a memory device) to store logic. Examples of a storage medium may include one or more types of processor-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described implementations. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain operation segment. The instructions may be implemented using any suitable high-level, low-level, object-oriented, visual, compiled and/or interpreted programming language.

The logical operations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language. The above specification, examples, and data, together with the attached appendices, provide a complete description of the structure and use of exemplary implementations.

1. A method for intelligently generating a sharing recommendation for a document stored on a sharing platform, the method comprising:
determining, for each of multiple versions of a document saved to the sharing platform, a deviation metric quantifying similarity of the version with another consecutively-saved version of the document;
evaluating the deviation metrics for the document in view of predefined readiness criteria indicating the document is nearing completion; and
responsive to determining that a subset of the deviation metrics for the document are characterized by a trend that satisfies the predefined readiness criteria, presenting a sharing recommendation on a user interface of the sharing platform.

2. The method of claim 1, wherein determining that the subset of deviation metrics are characterized by a trend that satisfies the predefined readiness criteria further comprises:
determining that the subset of deviation metrics for the document substantially converge.

3. The method of claim 1, wherein the deviation metric is a rate of modification for the document and wherein determining that the subset of deviation metrics are characterized by a trend that satisfies the predefined readiness criteria further comprises:
determining that one or more deviation metrics computed for the document is below a threshold.

4. The method of claim 1, wherein the deviation metric is a dot product computed with respect to a first embedding corresponding to a select version of the document and a second embedding corresponding to a consecutively-saved version of the document, and wherein identifying the subset of the deviation metrics that are characterized by a trend that satisfy predefined readiness criteria further include:
determining that the dot product exceeds a predefined threshold.

5. The method of claim 1, wherein the deviation metric is indicative of a quantity of text that is dissimilar between the version of the document and the consecutively-saved version of the document.

6. The method of claim 1, further comprising:
providing features of the document to a readiness predictor trained on a training dataset including:
features of previously-shared documents stored on the sharing platform; and
for each of the previously-shared documents, a corresponding computed value for the deviation metric;
receiving as output from the readiness predictor a predicted value for the deviation metric that is usable to assess sharing readiness of the document;
evaluating the predefined readiness criteria by comparing the predicted value for the deviation metric to the deviation metrics determined for the document; and
determining the predefined readiness criteria are satisfied when the predicted value and the subset of deviation metrics determined for the document satisfy predefined similarity criteria.

7. The method of claim 1, further comprising:
providing features of the document to a readiness predictor trained on document features for other documents stored on the platform, the document features for each select document of the other documents including:
revision history data for the select document; and
a binary indicator indicating whether or not the select document was shared;
providing the readiness predictor with features of the document, the features including the deviation metrics computed for the document; and
determining the predefined readiness criteria are satisfied responsive to receipt of a binary output from the readiness predictor indicating that the document is ready for sharing.

8. A processor-implemented method for intelligently rendering sharing recommendations for documents stored on a sharing platform, the method comprising:
providing a sharing readiness predictor with features of a first document, the sharing readiness predictor being trained on a dataset including:
document features for multiple versions of multiple documents; and
for each version of the multiple versions of each document of the multiple documents, a value indicating whether or not the version of the document was shared;
determining, by the sharing readiness predictor and based on the dataset, whether the features of the first document are characterized by a trend that satisfies predefined readiness criteria;
receiving as output from the sharing readiness predictor an indication that the first document is ready to be shared; and
responsive to receiving the indication, presenting a sharing recommendation.

9. The processor-implemented method of claim 8, wherein the document features for the multiple versions of the multiple documents include a deviation metric that quantifies similarity of two consecutively-saved versions of the document.

10. The processor-implemented method of claim 8, wherein the sharing readiness predictor is a team sharing readiness predictor trained on a dataset including:
the features for multiple versions of multiple documents stored on the sharing platform; and
for each version of the multiple versions of each document of the multiple documents, a value indicating whether or not the version of the document was shared at a team level, wherein the sharing recommendation includes a suggestion to share the document at the team level.

11. The processor-implemented method of claim 8, wherein the sharing readiness predictor is a publication readiness predictor trained on a dataset including:
the features for multiple versions of multiple documents stored on the sharing platform; and
for each version of the multiple versions of each document of the multiple documents, a value indicating whether or not the version was published, wherein the sharing recommendation includes a suggestion to publish the document.

12. The processor-implemented method of claim 8, wherein the features of the first document provided to the sharing readiness predictor include a value for a deviation metric value quantifying at least one of recent changes to the first document and predicted future changes to the first document.

13. The processor-implemented method of claim 12, wherein the deviation metric quantifies a modification rate computed with respect to two different versions of the document.

14. The processor-implemented method of claim 12, wherein the deviation metric quantifies a similarity of embeddings corresponding to different versions of the document.

15. A system for intelligently rendering a sharing recommendation for a document stored on a sharing platform;
a sharing readiness predictor stored in memory that:
determines, for each of multiple versions of a document saved to the sharing platform, a deviation metric quantifying similarity of the version with a consecutively-saved version of the document;
identifies a subset of the deviation metrics for the document that satisfy predefined readiness criteria; and
responsive to determining that the subset of deviation metrics for the document are characterized by a trend that satisfies the readiness criteria, presenting a sharing recommendation for the document on a user interface of the sharing platform.

16. The system of claim 15, wherein the deviation metric is a rate of modification for the document and wherein the sharing readiness predictor determines that the subset of deviation metrics are characterized by a trend that satisfies the predefined readiness criteria when each value in the subset of deviation metrics is below a threshold.

17. The system of claim 15, wherein the readiness criteria is satisfied when the deviation metrics for the document substantially converge.

18. The system of claim 15, wherein the deviation metric is a dot product computed with respect to a first embedding corresponding to the version of the document and a second embedding corresponding to the consecutively-saved version of the document, and wherein the readiness criteria is satisfied when the computed dot product exceeds a predefined threshold.

19. The system of claim 15, wherein the deviation metric is indicative of a quantity of text that is dissimilar between two versions of the document.

20. The system of claim 15, wherein the deviation metric is indicative of a quantity of text that is dissimilar between the version of the document and the consecutively-saved version of the document.
